(19) United States
(12) Patent Application Publication
(10) Pub. No.: US 2019/0000061 A1
(43) Pub. Date: Jan. 3, 2019

(54) METHOD FOR ATTRACTING OR FIXING PREDATORY INSECTS

(71) Applicant: NATIONAL AGRICULTURE AND FOOD RESEARCH ORGANIZATION, Tsukuba-shi, Ibaraki (JP)

(72) Inventors: Masami SHIMODA, Ibaraki (JP); Takuya UEHARA, Ibaraki (JP)

(21) Appl. No.: 15/748,949

(22) PCT Filed: Jun. 10, 2016
(86) PCT No.: PCT/JP2016/067326

§ 371 Date: Jan. 30, 2018

(30) Foreign Application Priority Data
Jul. 31, 2015 (JP) 151523/2015

(51) Int. Cl. A01M 1/04; A01M 17/00

(52) U.S. Cl. CPC A01M 1/04; A01M 2200/012; A01M 17/008

(57) ABSTRACT

The present invention has as its objects to provide a technique for effectively attracting or settling predatory insects, and to provide a means of effectively eliminating pests that can be preyed on by predatory insects.

The present invention provides a method for attracting or settling a predatory insect, the method comprising the step of irradiating violet light. This invention also provides a method for eliminating a pest using said method. This invention further provides an apparatus for attracting or settling a predatory insect, comprising a means of irradiating violet light, and an apparatus for eliminating a pest, comprising said means.

### TECHNICAL FIELD

The present invention relates to a method for attracting or settling predatory insects, a method for eliminating pests using said method, and an apparatus for attracting or settling predatory insects. More particularly, this invention relates to a method for attracting or settling predatory insects using irradiation of particular visible light, a method for eliminating pests using said method, and an apparatus for attracting or settling predatory insects which comprises an irradiation means of irradiating said visible light.

### BACKGROUND ART

With increasing use of agrochemicals since the 1950's, new pest individuals with agrochemical resistance have appeared one after another. Typical specific examples of those new pests are Aphis gossypii Glove with neonicotinoid resistance, and Scirtothrips dorsalis Hood with a mutationally acquired resistance to a wettable powder formulation of Fenpropathrin, and measures have been required to be taken against those pests. In addition to the development of agrochemical resistance, there has been concern about the deleterious effects of heavy use of chemical pesticides on the health of consumers and producers. One of the solutions to these problems is biological pest control using natural enemy insects, and it has been expected that native natural enemies inhabiting the local areas can be utilized (NPL 1).

The minute pirate bugs, Orius spp., are predatory insects with a body length of about 2 mm which prey on minute insects, and are widely distributed mainly in the tropical and temperature zones of the world. In Japan, Orius sauteri (Poppius), O. strigicollis (Poppius), O. minutus (Linnaeus), O. nagaii Yasunaga, O. tantillus (Motschulsky) and the like are widely distributed (NPLs 2-4). O. strigicollis has been already commercialized as a biological pesticide and mainly used in protected cultivation farms. While O. strigicollis is biasedly distributed in the southwest area of Japan, Orius sauteri is distributed all over Japan and thus is expected to be used as a native natural enemy in areas not inhabited by O. strigicollis. Orius sauteri, a predator which preys on fruit and vegetable pests such as Thrips palmi Karny (NPL 5) and aphids (NPL 6), had been sold as a biological pesticide but is not commercially available now. In order to increase the settlement rate of Orius sauteri and prolong its effect, there has been an attempt to introduce banker plants or insectary plants (NPL 7).

Tachinid flies are classified in the family Tachinidae of the order Diptera, and have a life history of parasitoidism. These flies live a lifestyle of spending most of their life in parasitizing other species, and finally devouring the host to death. One of known species of tachinid flies is Exorista japonica. Female flies of this species, after mating, lay eggs on the body surface of lepidopteran larvae (host). After hatching, fly larvae burrow into the body of their host, grow while feeding on the tissue of their host, and completely kill their host by the time they pupate. Since there are a wide range of lepidopterous insects that can be parasitized by Exorista japonica, this fly species is expected to be used as a natural enemy insect.

Insects are generally known to have a habit of gathering around light or avoiding light. By making use of this habit, the migration or spreading of insects can be controlled using light (NPLs 8, 9). For example, light traps using ultraviolet ray (NPL 10) and yellow sticky traps (NPL 11) have been found to be effective to collect Culicoides biting midges and Diaphorina citri Kuwayama, respectively. Also, greenhouses, etc., where near-ultraviolet rays are blocked by wavelength cutoff films, have been put to practice use as a pest control strategy, since it is hard for thrips to enter and spread in such houses (NPL 12).

The aforementioned approaches are all intended to capture or control pests themselves, whereas behavior control methods for natural enemy insects of pests using light have also been expected to be developed. For example, there has been a report of a method for controlling Tetranychidae by attracting its natural enemy Phytoseiidae (PTL 1). However, few studies have been made at present to investigate the light response of natural enemy insects (NPL 13). Also regarding Orius spp. and tachinid flies as mentioned above, no report has been published to investigate their light response.

### CITATION LIST

### Patent Literature

PTL 1: Japanese Patent No. JP 5294326

### Non Patent Literatures

NPL 1: Noda T. (2003) Plant Prot. 57: 524-529.
NPL 2: Yasunaga, T. (1997) Appl. Entomol. Zool. 32: 355-364.
NPL 3: Yasunaga, T. (1997) Appl. Entomol. Zool. 32: 379-386.
NPL 4: Yasunaga, T. (1997) Appl. Entomol. Zool. 32: 387-394.
NPL 5: Nagai, K., et al., (2000) Appl. Entomol. Zool. 35: 565-574.
NPL 6: Nakata, T (1994) Appl. Entomol. Zool. 29: 614-616.
NPL 7: Nagai, K., et al., (2012) Jpn. J. Appl. Entomol. Zool. 56: 57-64.
NPL 8: Johansen, N. S., et al., (2011) Ann. Appl. Biol. 159: 1-27.
NPL 9: Shimoda, M., et al., (2013) Appl. Entomol. Zool. 48: 413-421.
NPL 10: Yanase, T., et al., (2014) Jpn. J. Appl. Entomol. Zool. 58: 127-132.
NPL 11: Uechi, N., et al., (2014) Jpn. J. Appl. Entomol. Zool. 58: 119-125.
NPL 12: Ohta, I., et al., (2014) Jpn. J. Appl. Entomol. Zool. 58: 303-312.
NPL 13: Chen, Z., et al., (2012) Biocont. Sci. Technol. 22: 271-279.

### SUMMARY OF INVENTION

### Technical Problem

As described above, in order to promote widespread use of predatory insects in agricultural settings, it is essential to establish a technique for attracting those insects to growing facilities or agricultural fields or settling them therein, and yet there is at present no effective means other than the banker plant method. Besides, in the banker plant method, it is necessary to raise banker plants for maintaining natural pest enemies, together with crops; thus, this is not necessarily an effective pest control method from the viewpoints of time and effort, and securing of a growing space.

The present invention has been made in view of the aforementioned problems, and has as its objects to provide a technique for effectively attracting or settling predatory insects, and to provide, on that basis, a means of effectively eliminating pests that can be preyed on by predatory insects.

### Solution to Problem

The present inventors, focusing on the phototaxis of predatory insects in the process of searching for a strategy for attracting or settling those insects, have investigated the wavelength preference of predatory insects while developing an apparatus for testing insects. As a result, the inventors found that irradiation of visible light having a peak in a particular wavelength range (i.e., violet light), which has not been discussed in prior reports, is effective to attract or settle predatory insects. Based on this finding, the inventors have completed the present invention.

The present invention is preferably practiced according to the embodiments described below, but is not limited to these embodiments.

[1] A method for attracting or settling a predatory insect, comprising the step of irradiating violet light.
[2] The method as set forth in [1], wherein the violet light is light having a wavelength of 385 to 425 nm or 405 nm.
[3] The method as set forth in [1] or [2], wherein the violet light is irradiated by a light-emitting diode.
[4] The method as set forth in any of [1] to [3], wherein the violet light is irradiated in the mode (i) or (ii) as mentioned below:
(i) the violet light is irradiated onto a crop; or
(ii) the violet light is irradiated from the vicinity of a crop towards the outside of the crop.
[5] The method as set forth in any of [1] to [4], wherein the predatory insect is attracted or settled using a violet light source.
[6] The method as set forth in any of [1] to [5], wherein the predatory insect is attracted to or settled in the crop.
[7] The method as set forth in any of [1] to [6], wherein the predatory insect is a predatory bug or a tachinid fly.
[8] The method as set forth in [7], wherein the predatory bug is Orius sauteri (Poppius), O. strigicollis (Poppius), O. minutus (Linnaeus), O. nagaii Yasunaga, or O. tantillus (Motschulsky).
[9] The method as set forth in [7], wherein the tachinid fly is Exorista japonica, Ceromasia nigripes, Centeter cinerea, Epicampocera succincta, Phryxe vulgaris (Fallen), Masicera oculata, Neophryxe psychidis Townsend, or Blepharipa zebina.
[10] The method as set forth in any of [1] to [9], wherein the violet light is irradiated while ultraviolet light is blocked.
[11] The method as set forth in [10], wherein the ultraviolet light is light having a wavelength of not more than 365 nm.
[12] A method for eliminating a pest, comprising the step of attracting or settling a predatory insect using the method as set forth in any of [1] to [11].
[13] The method as set forth in [12], wherein the pest is a pest threatening a crop.
[14] An apparatus for attracting or settling a predatory insect, comprising a means of irradiating violet light.
[15] An apparatus for eliminating a pest, comprising a means of irradiating violet light.

### Advantageous Effects of Invention

According to the present invention, predatory insects can be effectively attracted or settled, thereby, for example, saving time, effort and space required in the banker plant method to raise banker plants. Also, since many insects are attracted by visible light such as yellow light, or ultraviolet ray, predatory insects such as predatory bugs and tachinid flies can be selectively attracted or settled by utilizing the techniques provided in this invention.

Further, in the present invention, by attracting or settling predatory insects, pests that can be preyed on by those predatory insects can be controlled effectively. Furthermore, in this invention, an apparatus for attracting or settling predatory insects, as well as an apparatus for eliminating pests that can be preyed on by predatory insects, can be provided on the basis of the methods mentioned above.

### BRIEF DESCRIPTION OF DRAWINGS

FIG. 1 shows a dodecagonal experimental arena used to investigate the wavelength preference of Orius sauteri. The experimental arena is composed of two transparent acrylic plates (top and bottom plates) and black semicircular spacers (partition plates), and test insects are released in a space sandwiched between the top and bottom plates. A filter paper was laid on the bottom plate. Test insects are placed in a plastic tube connected to the hole at the center of the bottom plate, and are allowed to voluntarily climb onto the arena. As light sources, different colors of light-emitting diodes (LEDs) are used, and the LEDs are installed on every other side of the arena.

FIG. 2 shows typical migration trajectories of Orius sauteri individuals towards particular light sources. The migration trajectories of Orius sauteri individuals, which start from the center of the arena, are indicated by solid line. As for the different LEDs, UV represents ultraviolet light, V represents violet light, B represents blue light, G represents green light, O represents orange light, and R represents red light.

FIG. 3 shows the percentages of unmated Orius sauteri individuals attracted to the respective colors of LEDs. Panel (A) shows the results for male individuals (44 of 120 individuals remained in a plastic tube), and Panel (B) shows the results for female individuals (59 of 130 individuals remained in a plastic tube). The vertical axis of the graphs represents the percentage (%) of attracted insects, and the bars and lines in the graphs represent means and standard errors (SE). The same lower-case alphabetic letter found above corresponding bars in the top and bottom graphs indicates that no significant difference (α=0.05) was found in the Tukey-Kramer's HSD test after ANOVA.

FIG. 4 shows the percentages of mated Orius sauteri individuals attracted to the respective colors of LEDs. Panel (A) shows the results for male individuals (19 of 70 individuals remained in a plastic tube), and Panel (B) shows the results for female individuals (26 of 70 individuals remained in a plastic tube). The vertical axis of the graphs represents the percentage (%) of attracted insects, and the bars and lines in the graphs represent means and standard errors (SE). The same lower-case alphabetic letter found above corresponding bars in the top and bottom graphs indicates that no significant difference (α=0.05) was found in the Tukey-Kramer's HSD test after ANOVA.

FIG. 5 shows the percentages of mated Orius sauteri individuals attracted to the respective colors of LEDs under the condition where ultraviolet light was replaced with white light (i.e., ultraviolet light was blocked). Panel (A) shows the results for male individuals, and Panel (B) shows the results for female individuals. The vertical axis of the graphs represents the percentage (%) of attracted insects, and the bars and lines in the graphs represent means and standard errors (SE).

FIG. 6 shows the departure rates of Orius sauteri individuals from the respective colors of LEDs. Panel (A) shows the results for unmated male individuals, Panel (B) represents the results for unmated female individuals, Panel (C) represents the results for mated male individuals, and Panel (D) represents the results for mated female individuals. In all graphs, the horizontal axis represents the departure rate (%) of Orius sauteri individuals.

FIG. 7 summarizes the results shown in FIGS. 3, 4 and the results shown in FIG. 6. Panel (A) shows the results for unmated male individuals, Panel (B) represents the results for unmated female individuals, Panel (C) represents the results for mated male individuals, and Panel (D) represents the results for mated female individuals. The bar charts show the percentages (%) of Orius sauteri individuals attracted to the respective colors of LEDs as shown in FIGS. 3 and 4, and the line charts show the departure rates (%) of Orius sauteri individuals from the respective colors of LEDs as shown in FIG. 6. In all graphs, the vertical axis represents the percentage (%) of attracted Orius sauteri individuals and the departure rate (%) of Orius sauteri individuals. The horizontal axis represents the wavelengths (nm) of different LEDs, or more specifically, represents ultraviolet light, violet light, blue light, green light, orange light, and red light in the order from left to right.

FIG. 8 shows the rates of settlement of Orius sauteri individuals in Sedum mexicanum. The left graph shows the results for male individuals, and the right graph shows the results for female individuals. In both graphs, the vertical axis represents the number of Orius sauteri individuals settled in Sedum mexicanum. The horizontal axis represents the types of LEDs—UV represents ultraviolet light, VL represents violet light, BL represents blue light, and GR represents green light.

FIG. 9 shows the results of electrophoresis conducted in the analysis of photoreceptor genes. The values found in the respective lanes represent the approximate nucleotide lengths of the genes amplified by PCR using different primers.

FIG. 10 shows the nucleotide sequences of cryptochrome (CRY) and opsin UV identified from Orius sauteri. The upper and lower halves of this figure show the nucleotide sequences of cryptochrome (CRY) and opsin UV, respectively.

FIG. 11 shows the list of primers used in the analysis of photoreceptor genes.

FIG. 12 shows the wavelength preference of Exorista japonica (i.e., the percentages of insects attracted to different colors of LEDs). Panel (a) shows the results for unmated male individuals, Panel (b) shows the results for mated male individuals, Panel (c) shows the results for unmated female individuals, and Panel (d) shows mated female individuals (n=50 per experimental plot). In all graphs, the vertical axis represents the percentage of attracted insects, and the bars represent averages of preference data. The horizontal axis represents the types of LED colors—UV represents ultraviolet light, VL represents violet light, BL represents blue light, GR represents green light, OR represents orange light, and R represents red light.

### DESCRIPTION OF EMBODIMENTS

(1) Method for Attracting or Settling Predatory Insects

The present invention provides a method for attracting or settling a predatory insect, and more particularly provides a method for attracting or settling a predatory insect, comprising the step of irradiating violet light.

In the present invention, by saying “attracting a predatory insect”, it is meant that a predatory insect that has not been present in a place of interest is lured from around the surroundings of said place. The period and extent of attracting a predatory insect is not particularly limited, and depending on the circumstances, it is only necessary that the predatory insect be finally present in a place of interest within a specified period of time. The predatory insect can be regarded as being attracted as long as at least one insect individual is present in the place of interest. Examples of the period of attracting a predatory insect include, but are not limited to, within 30 minutes, within 45 minutes, within one hour, within 2 hours, within 3 hours, within 5 hours, within 10 hours, within 12 hours, within one day, within 2 days, within 3 days, within 5 days, and within 10 days.

By saying “settling a predatory insect”, it is meant that a predatory insect present in a place of interest is caused to stay at said place within a specified period of time. The period of settling a predatory insect is not particularly limited, and examples of the stay period include at least one minute, at least 2 minutes, at least 3 minutes, at least 5 minutes, at least 10 minutes, at least 15 minutes, at least 20 minutes, at least 30 minutes, at least 45 minutes, at least one hour, at least 2 hours, at least 3 hours, at least 5 hours, at least 10 hours, at least 12 hours, at least one day, at least 2 days, at least 3 days, at least 5 days, and at least 10 days.

As referred to in the present invention, “violet light” refers to that part of visible light which is perceived as violet in human vision. Violet light is visible light having a wavelength of 380 to 450 nm, preferably 385 to 425 nm, more preferably 395 to 415 nm, most preferably 405 nm.

The light intensity of violet light is not particularly limited, and can be determined as appropriate depending on the circumstances of attracting or settling a predatory insect. For example, the light intensity, as expressed by photon flux density, is in the range of 1×10¹⁴ to 1×10¹⁹ photons·m⁻²·s⁻¹, preferably in the range of 1×10¹⁵ to 1×10¹⁸ photons·m⁻²·s⁻¹, more preferably in the range of 1×10¹⁶ to 1×10¹⁷ photons·m⁻²·s⁻¹. In the case of using a light irradiation apparatus, the light intensity setting can be varied by adjusting the radiant powder output of said apparatus as appropriate. Measurement of light intensity can be made with a per se known light intensity analyzer (e.g., commercially available analyzer).

The means of irradiating violet light is not particularly limited as long as it is capable of emitting violet light, and non-limiting examples of this means include light-emitting diode, fluorescent lamp, and incandescent lamp. Among them, a light-emitting diode is preferably used from the viewpoints of the efficiency of attracting or settling a predatory insect, energy saving, and the like. Another reason why the use of a light-emitting diode is preferred is that the light-emitting diode can reduce heat generation because of its low power consumption, thereby preventing the death of the attracted or settled predatory insect. In the case of using a light-emitting diode, light irradiation can be conducted with a lighting apparatus having attached thereto a plurality (e.g., a couple to several tens) of light-emitting elements (LED elements). If any power source is required for the means of irradiating violet light, a dry-cell battery, a lithium battery, a solar battery, or the like can be used as a power source.

Violet light can be irradiated as direct light or as scattered light (diffused light). Direct or scattered light can be adjusted by, for example, attaching a per se known fixture, such as lens or ring, near a light source. Direct light can be concentrated and irradiated to a certain irradiation point. The coverage of irradiation of direct light is not particularly limited and can be determined as appropriate depending on the circumstances of irradiating violet light. In the form of scattered light, violet light can be irradiated over a wide range. The coverage of irradiation of scattered light is not particularly limited and can be determined as appropriate depending on the circumstances of use.

In the present invention, the mode of irradiating violet light is not particularly limited, and any irradiation mode can be adopted as long as a predatory insect can be attracted or settled in said mode. In this invention, it is preferable, particularly from a pest control point of view, to attract a predatory insect to, or settle it in, a crop, and to irradiate violet light with a view to achieving this purpose.

As referred to herein, the “crop” refers to a product produced by agriculture, and can be interchangeably used with the term “agricultural product”. Also, the “crop” is meant to include not only edible portions such as fruit, but also all other portions exposed above the ground surface, such as leaf, stem, branch, trunk or seed.

Examples of the type of a crop to which the present invention is to be applied include, but are not particularly limited to, vegetables, cereals, fruits, flowers, and beans. Specific examples include, but are not particularly limited to, carrot, cucumber, radish, pumpkin, eggplant, tomato, cabbage, potato, Chinese cabbage, crown daisy, Brassica rapa var. perviridis, bell pepper, Welsh onion, onion, lettuce, ginger, garlic, mushrooms (e.g., Lentinula edodes), bamboo shoot, rice, wheat, corn, chrysanthemum, tulip, rose, soy, sesame, and peanut.

One step required to irradiate violet light for the purpose of attracting a predatory insect to, or settling it in, a crop is to install a violet light source in a farm. In this case, the number of a light source(s) to be installed in a farm can be adjusted, for example, as the number of a light source(s) per unit area (e.g., 10 acres (1000 m²)) of farm. The number of a light source(s) per unit area of farm is not particularly limited, and is for example in the range of 1 to 100000, preferably in the range of 10 to 50000, more preferably in the range of 100 to 10000.

One mode of irradiating violet light for the purpose of attracting a predatory insect to, or settling it in, a crop is to irradiate violet light onto a crop. In this mode of violet light irradiation onto a crop, violet light may be irradiated onto the crop directly from a light source or may be irradiated onto the crop indirectly through a reflector (e.g., planar mirror, convex or concave spherical mirror, paraboloidal mirror) or the like. By irradiating violet light onto the crop, a predatory insect can be directly attracted to or settled in the light-irradiated crop, or a predatory insect gathering around a violet light source can be indirectly attracted to or settled in the light-irradiated crop.

The distance of violet light irradiation onto a crop is not particularly limited, and can be determined as appropriate depending on various factors such as the scale of a farm where a crop of interest is cultivated. Even in the case where the crop is quite distant from a light source, a predatory insect can be attracted to or settled in the crop by adjusting the output intensity of violet light as appropriate (i.e., increasing the output intensity). Also, even in the case where the crop is not so distant from a light source, a predatory insect can be attracted to or settled in the crop by adjusting the output intensity of violet light as appropriate (i.e., decreasing the output intensity).

Violet light can be irradiated from an upper position above a crop downwards to the crop or can be irradiated from a lower position below the crop upwards to the crop. Also, violet light can be irradiated horizontally to a crop using a light source installed at the same height as the crop. The position of installation of a violet light source can be determined as appropriate depending on various factors such as the type of a crop of interest. Further, the height of installation of a violet light source can be changed as appropriate depending on the growth of a crop.

Violet light may be irradiated to the whole of a crop or a portion thereof. In the case of irradiation to a portion of a crop, it is preferable, from a pest control point of view, to apply violet light irradiation only to that portion of a crop where a pest to be controlled appears or gathers. The portion of a crop to be irradiated with violet light can be determined as appropriate depending on various factors such as the type of a crop or the type of a pest.

Violet light may be irradiated onto a crop from one place or from two or more places (e.g., 2, 3, 4, 5, 6, 7, 8, 9, 10 or more places). In the case of violet light irradiation from two or more places, beams of light may be intensively irradiated to one spot in a crop or may be irradiated to separate spots in a crop in an interspersed fashion.

Another mode of irradiating violet light is to irradiate violet light from the vicinity of a crop towards the outside of the crop. In this mode, a predatory insect approaching a violet light source can be effectively attracted to or settled in a crop located near the light source.

As referred to herein, the “vicinity of a crop” refers to a position that is not distant from but close to the crop. The distance (from a violet light source to a crop) can be defined for example as the distance from the stem (or trunk) of a crop. In this case, said distance is not particularly limited, and can be for example not longer than 5 m, preferably not longer than 1 m, more preferably not longer than 50 cm.

In this mode, by saying “irradiate . . . towards the outside of a crop”, it is meant that violet light is irradiated in a direction deviating from the center of a crop of interest. The direction and angle of irradiation of violet light are not limited as long as the violet light does not point towards the center of a crop. Also, the number of a light source(s) emitting violet light is not particularly limited, and may be only one or may be two or more (e.g., 2, 3, 4, 5, 6, 7, 8, 9, 10 or more).

As stated in the descriptions of the modes given above, a predatory insect approaching a light source emitting violet light can be utilized in the present invention. In other words, this invention makes it possible to attract or settle a predatory insect using a violet light source.

As described above, the present invention also makes it possible to attract a predatory insect to, or settle it in, a crop. This can be achieved in any mode—a predatory insect directly attracted to or settled in a crop irradiated with violet light may be utilized, or a predatory insect approaching a light source emitting violet light may be utilized.

As a predatory insect, an insect originally inhabiting the local area may be utilized, or an insect commercially available as a natural enemy insect formulation may be released and utilized. Or a predatory insect that has been captured in advance may be released in a farm where a crop of interest is raised. Where a predatory insect is intended to be artificially released, the methods of the present invention can be designed to further comprise the step of releasing a collected predatory insect.

The predatory insect to be used in the present invention is not particularly limited as long as it is an insect that preys on any other species of insects. The predatory insect may be an insect that preys on any other species of insects after growing into an adult, or may be an insect that parasitizes a host insect at a larval stage and feeds on the body of the host (i.e., parasitoid insect). Preferred examples of the predatory insect used in this invention include, but are not limited to, predatory bugs (e.g., Orius spp.) and tachinid flies.

The species of Orius spp. to be used is not particularly limited, and can be selected as appropriate depending on various factors such as the species of a pest to be controlled. Exemplary species of Orius spp. include, but are not limited to, Orius sauteri (Poppius), O. strigicollis (Poppius), O. minutus (Linnaeus), O. nagaii Yasunaga, O. tantillus (Motschulsky), and Nesidiocoris tenuis (Reuter). In the present invention, among those bugs listed above, Orius sauteri (Poppius) is preferably adopted as a predator to be attracted or settled.

The predatory bug to be attracted or settled can be male or female. Said predatory bug may be unmated or mated. In the present invention, it is preferable, but not particularly mandatory, to adopt an unmated predatory bug, particularly an unmated female predatory bug.

The species of a tachinid fly to be used is not particularly limited, and can be selected as appropriate depending on various factors such as the species of a pest to be controlled. Exemplary species of tachinid flies include, but are not limited to, Exorista japonica, Ceromasia nigripes, Centeter cinerea, Epicampocera succincta, Phryxe vulgaris (Fallen), Masicera oculata, Neophryxe psychidis Townsend, and Blepharipa zebina. In the present invention, among those tachinid flies listed above, Exorista japonica is preferably adopted as a predator to be attracted or settled.

The tachinid fly to be attracted or settled can be male or female. Said tachinid fly may be unmated or mated. In the present invention, it is preferable, but not particularly mandatory, to adopt a mated tachinid fly, particularly a mated male tachinid fly.

The present invention also provides, as another preferred embodiment, a method for attracting or settling a predatory insect, comprising the step of irradiating violet light while blocking ultraviolet light. As far as predatory bugs are concerned, by blocking ultraviolet light, the preference of a mated predatory bug (esp., mated female predatory bug) for violet light is enhanced, so that the predatory bug can be attracted or settled more effectively.

As referred to in the present invention, “ultraviolet light” refers to an invisible ray whose wavelength is shorter than that of visible ray and longer than that of X-ray. Ultraviolet light is an invisible ray having a wavelength of less than 380 nm, and the upper limit of wavelength of ultraviolet light is preferably not more than 365 nm. The lower limit of wavelength of ultraviolet light is generally not less than 10 nm, preferably not less than 200 nm, more preferably not less than 300 nm. “Ultraviolet light” as referred to in this invention includes UV-A (with a wavelength of not less than 315 nm and less than 380 nm), UV-B (with a wavelength of not less than 280 nm and less than 315 nm), UV-C (with a wavelength of not less than 200 nm and less than 280 nm), and far-ultraviolet ray (with a wavelength of not less than 10 nm and less than 200 nm).

The way of blocking ultraviolet light is not particularly limited, and examples of this way include use of a tool (e.g., glass, film, sheet, PVC material, plastic, cellophane) capable of blocking ultraviolet light transmission (so-called “UV protection”). By covering a plant where a predatory insect is to be attracted or settled with such a tool, ultraviolet light can be effectively blocked from sunlight. The form of covering a plant with such a tool is not particularly limited—plant individuals may be covered one by one, or an enclosed facility such as greenhouse may be constructed to cover the whole of a farm or part of plants in the farm. Also, the plant need not be necessarily covered completely with said tool, and said tool may be installed only on the top or sides of the plant.

The percentage of ultraviolet light to be blocked is not particularly limited to the extent that the rate of predatory insect attraction or settlement is enhanced, and said percentage is generally at least 50%, preferably at least 70%, more preferably at least 90%, particularly preferably 100%.

Although it is not intended to be particularly bound by theory, it is believed that attraction or settlement of predatory insects is involved by photoreceptor genes (or) found in those insects (or proteins encoded by these genes). Examples of these photoreceptor genes include, but are not particularly limited to, cryptochrome and opsin UV (also called “UV opsin”). Cryptochrome is a blue light receptor, and opsin UV is an ultraviolet light receptor. The nucleotide sequences of these genes and the amino acid sequences encoded thereby can vary with the species of predatory insects. In the case of Orius sauteri, the nucleotide sequences of the cryptochrome and opsin UV genes are represented by SEQ ID NOs:1 and 2, respectively. Predatory insects having these photoreceptor genes can be selected as the predatory insects to be used in the present invention.

For example, the predatory insect that can be used in the methods of the present invention may be a predatory insect having the following two photoreceptor genes: a nucleotide sequence encoding a blue light receptor and having a nucleotide sequence identity of at least 80%, preferably 85%, 90% or 95%, to SEQ ID NO:1; and a nucleotide sequence encoding an ultraviolet light receptor and having a nucleotide sequence identity of at least 80%, preferably 85%, 90% or 95%, to SEQ ID NO:2.

In the present specification, the percent identity between two nucleotide sequences can be determined by visual inspection and mathematical calculation, or can be determined using a computer program. Examples of the sequence comparison computer program include the BLASTN program available on the website of the National Library of Medicine (http://blast.ncbi.nlm.nih.gov/Blast.cgi) (Altschul, et al., (1990) J. Mol. Biol. 215: 403-10), or the UW-BLAST2.0 algorithm. Standard default parameter settings for UW-BLAST2.0 are available by reference to the following website: http://blast.wustl.edu.

The pest to be controlled by attracting or settling a predatory insect is not particularly limited, but is preferably a pest threatening a crop (i.e., a pest damaging a crop) from a crop protection point of view. The damage to a crop may be direct damage to its edible portion such as fruit, or may be impairment of the growth of a crop itself caused by damage to its inedible portion even in the absence of any direct damage to its edible portion.

The pest to be controlled is preferably, but is not particularly limited to, a minute pest. The minute pest can be of any species as long as it can be preyed on by a predatory insect. Examples of the minute pest that can be preyed on by predatory bugs include, but are not particularly limited to, thrips, aphids, and red mites. Examples of the pest that can be preyed on (parasitized) by tachinid flies include, but are not particularly limited to, lepidopteran insects (pests). Exemplary lepidopteran insects include, but are not particularly limited to, Mythimna separata (Walker), Helicoverpa armigera (Hubner), Psilogramma increta, Stagonopleura bella, and Phalera flavescens. The lepidopteran insect that can be preyed on (parasitized) by tachinid flies is preferably at a larval stage.

(2) Pest Elimination Method

The present invention also provides a method for eliminating a pest using the method for attracting or settling a predatory insect as described above in (1). The pest elimination method of this invention is characterized by comprising the step of attracting or settling a predatory insect using the method described above in (1). Since the inventive pest elimination method utilizes the method of (1) above, all definitions, terminologies, and other related matters used in relation to this pest elimination method can be understood in full line with the descriptions given above in (1).

(3) Apparatus for Attracting or Settling a Predatory Insect

Based on the descriptions given hereinabove, the present invention further provides an apparatus for attracting or settling a predatory insect. Since violet light irradiation is utilized to attract or settle a predatory insect, the inventive apparatus is characterized by comprising a means of irradiating violet light. All definitions, terminologies, and other related matters used in relation to the inventive apparatus for attracting or settling a predatory insect can also be understood in full line with the descriptions given above.

As described above, the means of irradiating violet light is not particularly limited as long as it is capable of emitting violet light, and non-limiting examples of this means include light-emitting diode, fluorescent lamp, and incandescent lamp. Among them, a light-emitting diode is preferably used from the viewpoints of the efficiency of attracting or settling a predatory insect, energy saving, and the like. Another reason why the use of a light-emitting diode is preferred is that the light-emitting diode can reduce heat generation because of its low power consumption, thereby preventing the death of the attracted or settled predatory insect. In the case of using a light-emitting diode, light irradiation can be conducted with a lighting apparatus having attached thereto a plurality (e.g., a couple to several tens) of light-emitting elements (LED elements). If any power source is required for the means of irradiating violet light, a dry-cell battery, a lithium battery, a solar battery, or the like can be used as a power source.

The mode of the apparatus for attracting or settling a predatory insect according to the present invention is not particularly limited, and said inventive apparatus can be provided in different modes. One of the modes of apparatus is, for example, a planar apparatus. For example, the planar apparatus may have a violet light irradiation means in its interior, and irradiate violet light through its light transmitting section. Or the planar apparatus may have a violet light irradiation means on the surface of its planar plate, and irradiate violet light from the surface of said apparatus. The materials, components and other elements of the planar apparatus can be made of aper se known member, and the light transmitting section of said apparatus can be made of a member capable of transmitting light, such as plastic, glass, or cellophane.

Another mode of apparatus is, for example, a bulb-type apparatus. This mode of apparatus is preferably a relatively large light bulb, for the purpose of effectively attracting or settling a predatory insect. A lamp-type lighting apparatus with a shade is also preferred for the purpose of concentrating light on one irradiation spot. The bulb-type apparatus may, for example, have a violet light irradiation means in the interior of its bulb, and irradiate violet light from the surface of its bulb. The materials, components and other elements of the bulb-type apparatus can also be made of a per se known member.

The bulb-type apparatus can be exemplified, as further another mode of apparatus, by a bulb-type apparatus in a rope shape. Such a rope-shaped apparatus is also called rope light, tube light, or the like. The bulb-type apparatus in a rope shape may, for example, have a violet light irradiation means in the interior of its flexible, rope-shaped component (rope section), and irradiate violet light at a position where the rope section exists. Or said rope-shaped apparatus may have a violet light irradiation means on the surface of the rope section. It is preferable, but not mandatory, that the violet light irradiation means be present in the rope section at regular intervals. The materials, components and other elements of this apparatus can also be made of a per se known member, and the rope section of said apparatus can be made of a polymer such as polyvinyl chloride.

The lighting apparatus for use in attracting or settling a predatory insect may be an apparatus using a fluorescent tube. A fluorescent lamp emitting violet light only can be used to make a fluorescent lamp-like apparatus.

In the present invention, it is also possible to use an apparatus that can irradiate violet light without the use of a light emitting apparatus. For example, with the use of a reflective or transmissive plate-type apparatus, violet light alone is reflected or transmitted from a light source with a wide spectrum of wavelengths from ultraviolet to infrared, such as sunlight or xenon light source, whereby violet light can be irradiated onto a plant where a predatory insect is to be attracted or settled. The transmissive apparatus is exemplified by facility materials for use in greenhouse or the like. By covering a plant of interest with a tool (e.g., glass, film, sheet, PVC material, plastic, cellophane) capable of transmitting violet light only, irradiation of violet light can be done effectively. The plant of interest needs not be necessarily covered completely with said tool, and said tool may be installed only on the top or sides of the plant. The apparatus of this invention may comprise not only the tool capable of transmitting violet light alone but also a tool capable of blocking ultraviolet light (i.e., an ultraviolet light blocking means) (e.g., glass, film, sheet, PVC material, plastic, cellophane). By concurrently using such a tool capable of blocking ultraviolet light, it is possible to effectively attract or settle a predatory insect. The details of blocking ultraviolet light are as described above.

(4) Pest Elimination Apparatus

Based on the descriptions given hereinabove, the present invention further provides an apparatus for eliminating a pest by means of attracting or settling a predatory insect. The pest elimination apparatus of this invention is characterized by comprising a means of irradiating ultraviolet light. The inventive pest elimination apparatus can also utilize the apparatus described above in (3). Therefore, said pest elimination apparatus can be configured in full line with the descriptions given above in (3). Also, all definitions, terminologies, and other related matters used in relation to the inventive pest elimination apparatus can be understood in full line with the descriptions given above.

### EXAMPLES

Hereunder, the present invention will be specifically described by way of working examples, but these examples are not intended to limit the technical scope of this invention. Those skilled in the art can easily make modifications and variations to this invention based on the descriptions contained herein, and such modifications and variations are also included within the technical scope of this invention.

### Example 1. Wavelength Preference of Orius sauteri

As insects to be tested, Orius sauteri individuals were used. The bugs were placed in a plastic rearing box with a width of 45 mm, a depth of 235 mm, and a height of 170 mm. With eggs of Ephestia kuehniella being used as a feed, and Sedum mexicanum being put as a substrate for water supplement and spawning, the bugs were reared in groups at 25° C. and in a cycle of 16-hour light and 8-hour darkness. In order to obtain unmated adult bugs, 4.5-instar larvae were taken out of the rearing box, and placed into test tubes with a diameter of 10 mm and a height of 5 mm to rear them individually while the feed was exchanged at a frequency of twice per week. After hatched adults were determined for sex, the adult bug individuals after 3 days to 1 week of hatching were put to test use as unmated individuals. Further, a pair of male and female adults after 2 days of hatching were put into one test tube, left to stand for 3 days to mate them with each other, and separated into male and female by the end of the day to put them to test use as mated individuals.

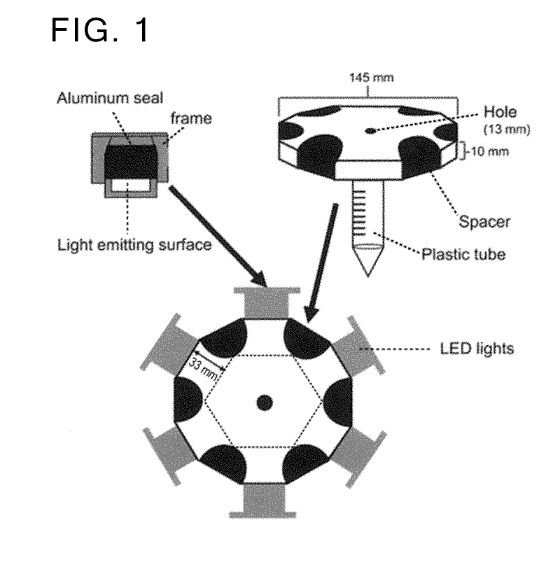

The behavior of Orius sauteri individuals was observed in a dodecagonal arena (FIG. 1). The experimental arena was composed of two transparent acrylic plates (top and bottom plates) and black semicircular spacers (partition plates), and test insects were released in a space sandwiched between the top and bottom plates. A filter paper was laid on the bottom plate so as to make it easy to identify the position of test insects. Each 10 adult insects were put into a plastic tube (CELLSTAR, produced by Greiner Bio-One, Germany), which was then connected to the hole at the center of the bottom plate to allow the test insects to voluntarily climb onto the arena. As light sources, different colors of light-emitting diodes (LEDs) (LDF 26 series, produced by CCS Inc., Japan) were used to emit ultraviolet light (peak wavelength (λp)=365 nm), violet light (λp=405 nm), blue light (λp=450 nm), green light (λp=525 nm), orange light (λp=590 nm), and red light (λp=660 nm), respectively. The LEDs were installed on every other side of the arena. Light intensity was controlled by a DC power supply (P4K36-0.1, produced by Matsusada Precision Inc., Japan) using an optical bench at a position of 35 cm from a light source, so as to give a photon flux density of 6×10¹⁶ photons·m⁻²·s⁻¹.

The observation was done in a dark box made of wood (0.6 m×0.6 m×1 m) after 9 to 12 hours from the start of the light period during rearing of Orius sauteri Individuals. The entire arena was irradiated by an infrared irradiator (peak wavelength=840 nm), and the walking behavior of Orius sauteri individuals was recorded by an infrared camera (Himawari GE60, produced by Library Co., Ltd., Japan). One minute after the plastic tube containing Orius sauteri individuals was installed, LEDs were turned on, and the observation was continued until every insect individual showed a preference for any of the wavelengths. As a criterion for determining wavelength preference, an insect individual reaching within a distance of not more than 33 mm from a certain LED (i.e., a distance from an LED light-emitting surface to a dotted line in FIG. 1) was regarded as showing a preference for the wavelength of said LED.

In each experiment, the percentages of Orius sauteri individuals preferring respective wavelengths were calculated, and the averages of the calculated percentages were compared among the different wavelengths. The percentages were arcsine-transformed, analyzed by ANOVA, and subjected to multiple comparison by the Tukey's HSD method. Statistical analysis was carried out using R3.0.1 (R Core Team, 2013).

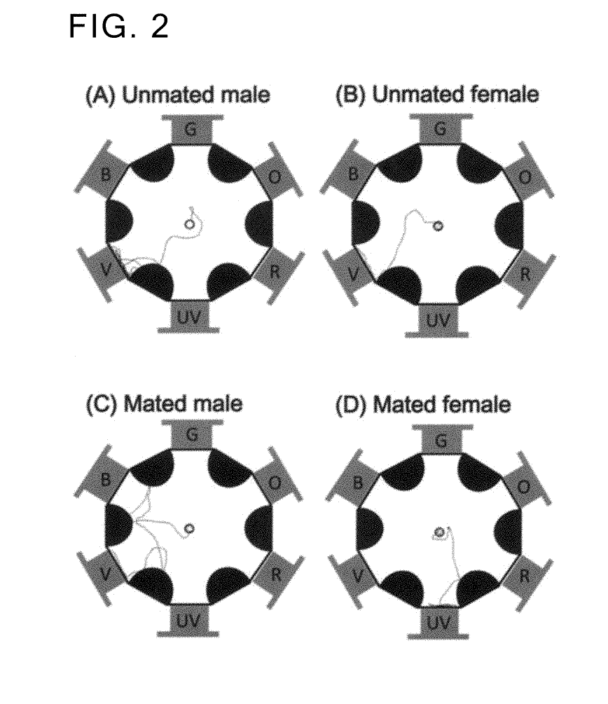

All Orius sauteri individuals entering the arena from the hole at the center walked to approach any of LED light sources. Most individuals did not go straight to a light source immediately after getting out of the hole at the center, and turned around or drew a circumferential trajectory before showing a preference for a certain light source (FIG. 2). Among all individuals, the slowest one took a maximum of 7 minutes to show a preference for any of the wavelengths.

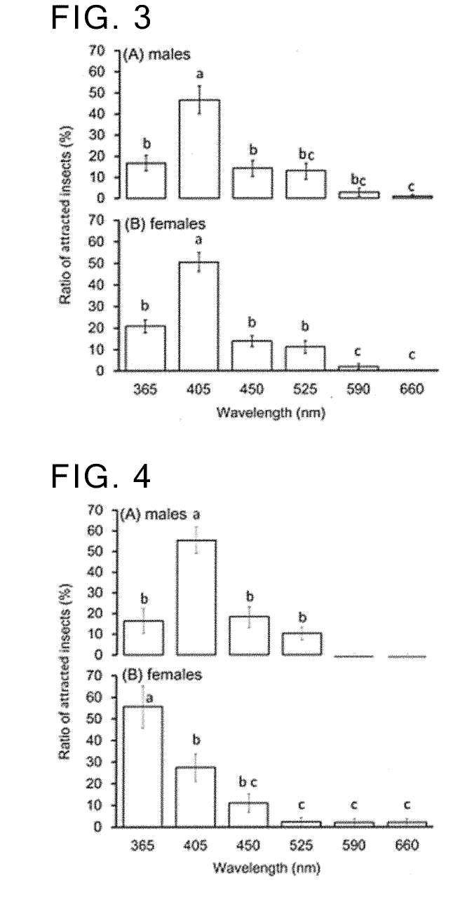

Of 120 unmated males tested (10 males×12 runs), 76 moved into the arena. The preference of the individuals moving into the arena varied significantly with wavelengths (p<0.05, ANOVA), and they showed the highest preference for violet light (46.7% as an average over 12 runs in the Tukey's HSD test) (FIG. 3A). Of 130 unmated females tested, 71 moved into the arena and showed the highest average preference for violet light over 13 runs (50.6% in the Tukey's HSD test) (FIG. 3B). Of 70 males tested, which had experienced 3 days of mating, 51 moved into the arena and showed a significantly high preference for violet light (55.3% as an average over 7 runs in the Tukey's HSD test) (FIG. 4A).

In contrast, 44 of 70 mated females tested (10 females×7 runs) moved into the arena and were most strongly attracted to ultraviolet light (55.7% as an average over 7 runs in the Tukey's HSD test), but the number of mated females attracted to violet light was also relatively high (FIG. 4B). In all experimental plots, the percentages of individuals remaining in test tubes, excluding dead individuals, were as follows: 23.8% of unmated males, 13.1% of unmated females, 26.5% of mated males, and 30.5% of unmated females.

The results given above revealed that Orius sauteri is strongly attracted to violet light. Although it was reported that mated female individuals were attracted to ultraviolet light, there were also a sufficient number of mated female individuals which were attracted to violet light. Given the fact that many other species of insects are attracted to ultraviolet light, it can be understood that irradiation of violet light is sufficiently useful for attracting Orius sauteri.

### Example 2. Wavelength Preference of Orius sauteri Under the Condition where Ultraviolet Light is Blocked

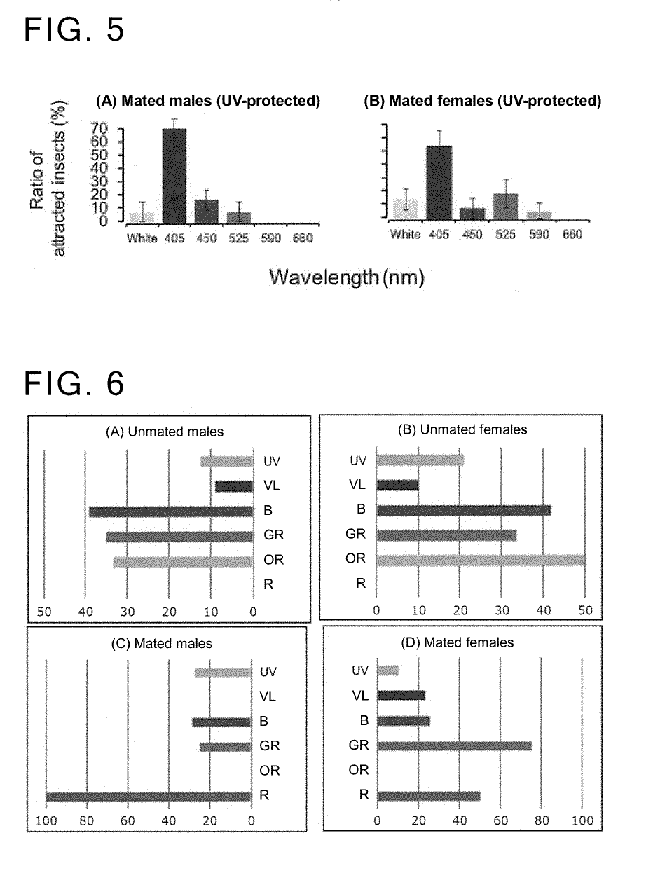

In a similar experiment to that described above in Example 1, the wavelength preference of Orius sauteri was investigated, with the proviso that ultraviolet light was blocked by replacing it with white light. Under this condition, about 55% of individuals, which were even mated females, showed a preference for violet light. Also, about 70% of mated male individuals showed a preference for violet light—this was an increase by about 10% as compared with the percentage under the condition where six different colors of LEDs were lighted up (FIG. 5). The results given above revealed that the use of irradiation of violet light in combination with blocking of ultraviolet light is not only effective even in mated female individuals, but also has a dramatic enhancing effect on the attraction activity of mated male individuals.

### Example 3. Settlement of Orius sauteri

The phototaxis of Orius sauteri was observed while six colors of LEDs emitting ultraviolet light (λp=365 nm), violet light (λp=405 nm), blue light (λp=450 nm), green light (λp=525 nm), orange light (λp=590 nm), and red light (λp=660 nm) were lighted up in a dodecagonal arena as described above. In order to investigate the settlement of Orius sauteri, the percentage of Orius sauteri individuals arriving at a certain LED and then departing from said LED was determined. The percentage of Orius sauteri individuals departing from an LED was calculated by the following equation.

$$Departure rate ( \% ) = \frac{Departing individuals}{Arriving individuals} \times 100$$

The results of analyzing the departure rate are shown in FIG. 6. It was found that unmated individuals, both male and female, showed a low rate of departure from violet light (FIGS. 6A, B). Incidentally, unmated individuals showed a 0% rate of departure from red light, but this is because the calculations were in the first place done based on the extremely low numbers of individuals arriving at the red LED; thus, such a departure rate was not sufficient to evaluate the settlement of Orius sauteri. Mated male individuals were observed to show the lowest rate of departure from violet light (FIG. 6C). In contrast, in mated female individuals, the departure rate from ultraviolet light was the lowest, but the departure rate from violet light was also sufficiently low (FIG. 6D). Given the aforementioned fact that many species of insects are attracted to or settled in ultraviolet light, it can be understood that irradiation of violet light is sufficiently useful for settlement of Orius sauteri. Incidentally, mated individuals showed a 0% rate of departure from orange light, but this is because, as in the case of unmated individuals arriving at red light, the calculations were in the first place done based on the extremely low numbers of mated individuals arriving at the orange LED.

The results shown in FIGS. 3, 4 and 6 are summarized in FIG. 7. As is evident from the results in FIG. 7, it can be understood that irradiation of violet light is the most effective from the viewpoints of attraction and settlement of Orius sauteri.

### Example 4. Rate of Settlement in Sedum mexicanum Irradiated with Light

In an outdoor greenhouse, potted plants of Sedum mexicanum were placed at four places, and were each irradiated with any of LEDs emitting ultraviolet light (λp=365 nm), violet light (λp=405 nm), blue light (λp=450 nm), and green light (λp=530 nm). In the early evening, Orius sauteri individuals (mated) settled in Sedum mexicanum were released at the center of the experimental facility, and LEDs were lighted up during the night. In the morning of the next day, the numbers of individuals migrating to and settled in each of the experimental plots were counted. This test was conducted twice.

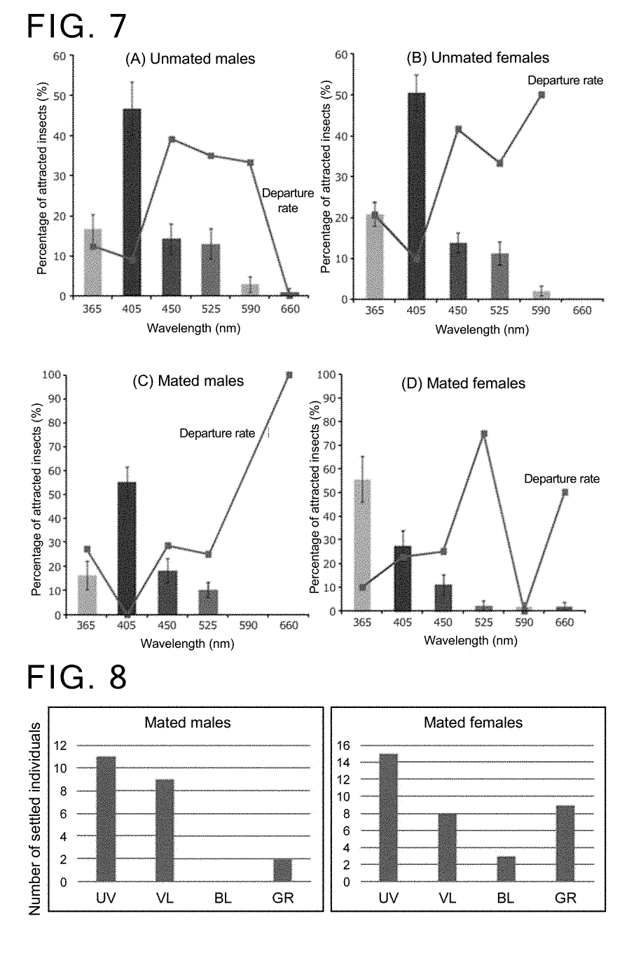

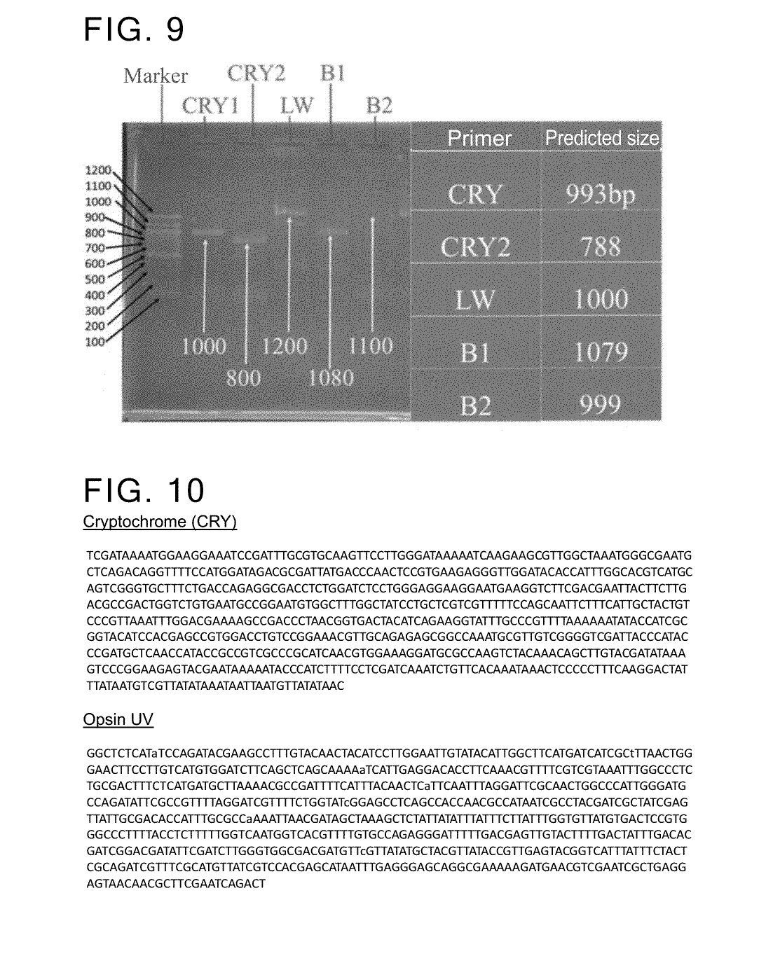

The results showed that the numbers of individuals, both male and female, settled in ultraviolet light were the highest, but the numbers of individuals settled in violet light were also sufficiently high (FIG. 8). Female individuals were observed to show a high rate of settlement in green light, while no similar results were observed in males. The results given above revealed that irradiation of violet light is the most effective for selectively settling Orius sauteri individuals, both male and female.

### Example 5. Analysis of Photoreceptor Genes

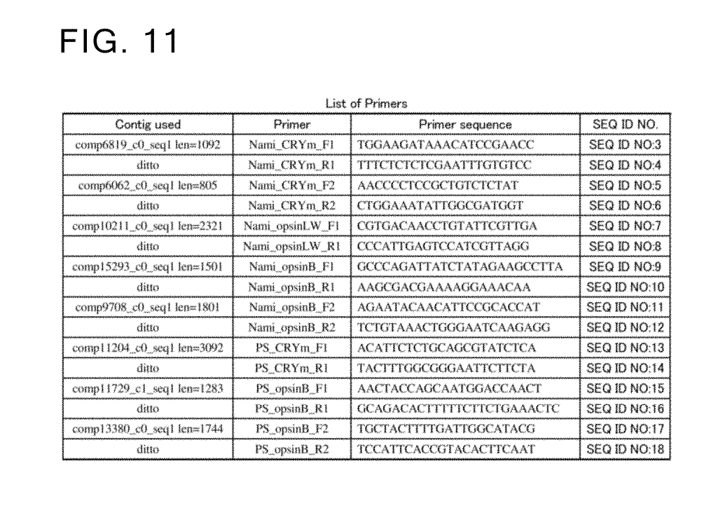

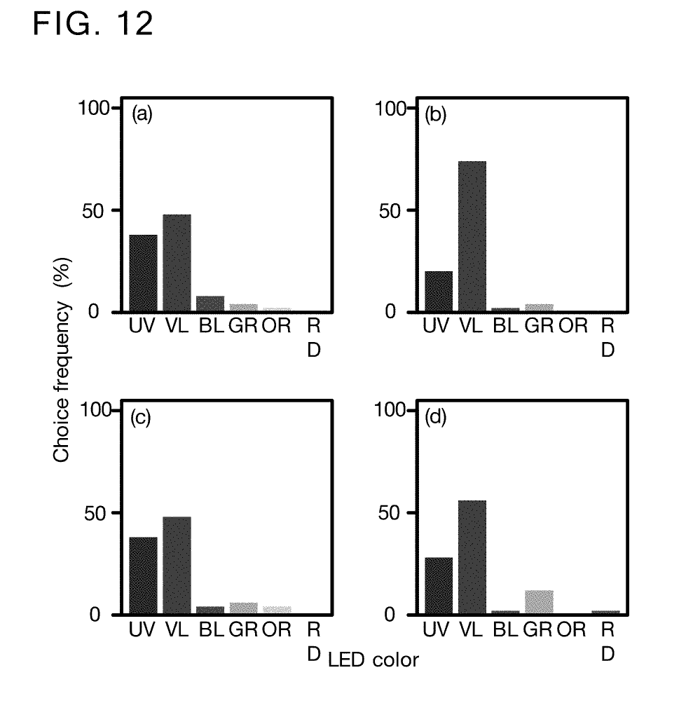

Twenty individuals of Orius sauteri were place in a 1.5 mL tube, and cryopreserved at −20° C. To the tube, 100 μL of TRIzol for RNA extraction (produced by Eppendorf) was added, and the mixture was subjected to homogenization followed by RNA precipitation with ethanol. After ethanol was vaporized, 30 μL of ultrapure water was added, and the mixture was left to stand for 5 minutes and mixed by vortexing to dissolve RNA. Next, cDNA synthesis was conducted using PrimeScript™ RT reagent Kit (Perfect Real Time, produced by Takara Bio Inc., RR037A). The primers used in the cDNA synthesis are shown in FIG. 11.

With the synthesized cDNA being used as a template, PCR was conducted with TaKaRa Ex-Taq (produced by Takara Bio Inc.). The PCR products resulting from PCR reactions were separated by electrophoresis. After the electrophoresis, agarose gel in the electrophoresis tank was transferred to a horizontally disposed tray, ethidium bromide was added as a staining agent, and the mixture was left to stand for about 15 minutes. Then, UV light was irradiated to check for the presence of DNA band.

Next, DNA was extracted directly from the DNA band using Wizard® SV Gel and PCR Clean-UP System (produced by Promega). With the extracted PCR product being used as a template, DNA sequencing (nucleotide sequencing) was performed by the Big Dye method using BigDye Terminator v3.1 Cycle Sequencing Kit (produced by Applied Biosystems).

### Example 6. Measurement of Compound Eye Spectral Sensitivity

With electrodes being inserted into the retinas of unmated or mated individuals of Orius sauteri, different wavelengths of light were irradiated to measure the excitements of the visual cells of the bugs as potential differences. The potential differences in visual cells were measured with a microelectrode amplifier (MEZ-7200, produced by Nihon Kohden Corporation). Five individuals of Orius sauteri were used in the test, and the means and standard deviations were calculated for these individuals.

The measurement results of compound eye spectral sensitivity revealed that both mated and unmated individuals of Orius sauteri showed high sensitivity at wavelengths around 365 nm (violet light) and 530 nm (green light). This sensitivity distribution is presumed to depend on the photoreceptors UV opsin and LW opsin.

The above results also showed that Orius sauteri individuals have low sensitivity to violet light (380 to 450 nm). The reason why Orius sauteri individuals were nevertheless actually attracted to or settled in violet light is considered to be due to the effects of the two photoreceptors identified in Example 5, i.e., opsin UV and cryptochrome. More specifically, since opsin UV and cryptochrome are sensitive to ultraviolet light and blue light, respectively, it was considered that Orius sauteri individuals may be attracted to or settled in violet light whose wavelength is in the middle of the range between the peak wavelengths to which the two photoreceptors are reactive.

### Example 7. Wavelength Preference of Exorista japonica

In this study, Exorista japonica individuals were used as insects to be tested. The Exorista japonica individuals used were tachinid flies that had been collected in Tsukuba city of Ibaraki prefecture in Japan and had been reared indoors through consecutive generations. As a host, Mythimna separate moths reared with an artificial diet (Silkmate 2M) were used. Exorista japonica larvae grow by feeding on the tissue of Mythimna separate, exit from host insects by breaking the host epidermis, and form their pupae. Those tachinid fly individuals whose pupae were at least 50 mg in weight were picked up and used in the experiments within one week after eclosion. Exorista japonica adults were reared in a plastic container (100 mmφ×40 mmH) with lumps of sugar and absorbent cotton soaked with water. The rearing and experiments were all conducted at a room temperature of 25° C. and in a 16-hour light/dark cycle (8-hour light period, 8-hour dark period).

The behavior of Exorista japonica individuals was observed in a dodecagonal arena as in Example 1. The experimental arena was composed of two transparent acrylic plates (top and bottom plates) and black semicircular spacers (partition plates), and test insects were released in a space sandwiched between the top and bottom plates. A filter paper was laid on the bottom plate so as to make it easy to identify the position of test insects. One adult insect was put into each plastic tube (CELLSTAR, produced by Greiner Bio-One, Germany), which was then connected to the hole at the center of the bottom plate to allow the test insect to voluntarily climb onto the arena. As light sources, different colors of light-emitting diodes (LEDs) (LDF 26 series, produced by CCS Inc., Japan) were used to emit ultraviolet light (λp=365 nm), violet light (λp=405 nm), blue light (λp=450 nm), green light (λp=525 nm), orange light (λp=590 nm), and red light (λp=660 nm), respectively. The LEDs were installed on every other side of the arena. Light intensity was controlled by a DC power supply (P4K36-0.1, produced by Matsusada Precision Inc., Japan) using an optical bench at a position of 35 cm from a light source, so as to give a photon flux density of 6×10¹⁶ photons·m⁻²·s⁻¹.

The observation was done in a dark box made of wood (0.6 m×0.6 m×1 m). The entire arena was irradiated by an infrared irradiator (peak wavelength=840 nm), and the walking behavior of Exorista japonica individuals was recorded by an infrared camera (Himawari GE60, produced by Library Co., LTD., Japan). After the plastic tube containing an Exorista japonica individual was installed, LEDs were turned on, and the measurement was started from the time when the fly voluntarily climbed onto the arena. As a criterion for determining wavelength preference, an insect individual arriving at a certain LED was regarded as showing a preference for the wavelength of said LED.

A total of 50 individuals were tested in each experimental plot. In each experiment, the percentages of Exorista japonica individuals preferring respective wavelengths were calculated, and the calculated percentages were compared among the different wavelengths.

Fourty-eight percent of unmated Exorista japonica individuals, both male and female, showed a preference for violet light. Among mated individuals, 56% of females and 74% of males showed a preference for violet light. Irrespective of sex differences and previous mating experience, a majority of individuals tested in every experimental plot showed a preference for violet light.

The results given above showed that Exorista japonica is strongly attracted to violet light. It was also found that mated Exorista japonica individuals show a higher preference for violet light than unmated ones, and that mated females individuals are more strongly attracted to violet light than male ones.

### INDUSTRIAL APPLICABILITY

The present invention is particularly useful in agricultural field from the viewpoint of effective protection of crops through pest control. By utilizing the techniques provided in this invention, predatory insects can be attracted or settled effectively and selectively, and pests that can be preyed on by predatory insects can be controlled effectively.

1. A method for attracting or settling a predatory insect, comprising the step of irradiating violet light.

2. The method according to claim 1, wherein the violet light is light having a wavelength of 385 to 425 nm or 405 nm.

3. The method according to claim 1, wherein the violet light is irradiated by a light-emitting diode.

4. The method according to claim 1, wherein the violet light is irradiated in the mode (i) or (ii) as mentioned below:
(i) the violet light is irradiated onto a crop; or
(ii) the violet light is irradiated from the vicinity of a crop towards the outside of the crop.

5. The method according to claim 1, wherein the predatory insect is attracted or settled using a violet light source.

6. The method according to claim 1, wherein the predatory insect is attracted to or settled in the crop.

7. The method according to claim 1, wherein the predatory insect is a predatory bug or a tachinid fly.

8. The method according to claim 7, wherein the predatory bug is Orius sauteri (Poppius), O. strigicollis (Poppius), O. minutus (Linnaeus), O. nagaii Yasunaga, or O. tantillus (Motschulsky).

9. The method according to claim 7, wherein the tachinid fly is Exorista japonica, Ceromasia nigripes, Centeter cinerea, Epicampocera succincta, Phryxe vulgaris (Fallen), Masicera oculata, Neophryxe psychidis Townsend, or Blepharipa zebina.

10. The method according to claim 1, wherein the violet light is irradiated while ultraviolet light is blocked.

11. The method according to claim 10, wherein the ultraviolet light is light having a wavelength of not more than 365 nm.

12. A method for eliminating a pest, comprising the step of attracting or settling a predatory insect using the method according to claim 1.

13. The method according to claim 12, wherein the pest is a pest threatening a crop.

14. An apparatus for attracting or settling a predatory insect, comprising a means of irradiating violet light.

15. An apparatus for eliminating a pest, comprising a means of irradiating violet light.


SEQUENCE LISTING (18 sequences)

SEQ ID NO: 1 - DNA, 690 bp, Orius sauteri
tcgataaaatggaaggaaatccgatttgcgtgcaagttccttgggataaaaatcaagaagcgttggctaaatgggcgaatgctcagacaggttttccatggatagacgcgattatgacccaactccgtgaagagggttggatacaccatttggcacgtcatgcagtcgggtgctttctgaccagaggcgacctctggatctcctgggaggaaggaatgaaggtcttcgacgaattacttcttgacgccgactggtctgtgaatgccggaatgtggctttggctatcctgctcgtcgtttttccagcaattctttcattgctactgtcccgttaaatttggacgaaaagccgaccctaacggtgactacatcagaaggtatttgcccgttttaaaaaatataccatcgcggtacatccacgagccgtggacctgtccggaaacgttgcagagagcggccaaatgcgttgtcggggtcgattacccatacccgatgctcaaccataccgccgtcgcccgcatcaacgtggaaaggatgcgccaagtctacaaacagcttgtacgatataaagtcccggaagagtacgaataaaaatacccatcttttcctcgatcaaatctgttcacaaataaactccccctttcaaggactatttataatgtcgttatataaataattaatgttatataac

SEQ ID NO: 2 - DNA, 690 bp, Orius sauteri
ggctctcatatccagatacgaagcctttgtacaactacatccttggaattgtatacattggcttcatgatcatcgctttaactgggaacttccttgtcatgtggatcttcagctcagcaaaaatcattgaggacaccttcaaacgttttcgtcgtaaatttggccctctgcgactttctcatgatgcttaaaacgccgattttcatttacaactcattcaatttaggattcgcaactggcccattgggatgccagatattcgccgttttaggatcgttttctggtatcggagcctcagccaccaacgccataatcgcctacgatcgctatcgagttattgcgacaccatttgcgccaaaattaacgatagctaaagctctattatatttatttcttatttggtgttatgtgactccgtgggcccttttacctctttttggtcaatggtcacgttttgtgccagagggatttttgacgagttgtacttttgactatttgacacgatcggacgatattcgatcttgggtggcgacgatgttcgttatatgctacgttataccgttgagtacggtcatttatttctactcgcagatcgtttcgcatgttatcgtccacgagcataatttgagggagcaggcgaaaaagatgaacgtcgaatcgctgaggagtaacaacgcttcgaatcagact

SEQ ID NO: 3 - DNA, 21 bp, Artificial Sequence
  primer
tggaagataaacatccgaacc

SEQ ID NO: 4 - DNA, 22 bp, Artificial Sequence
  primer
tttctctctcgaatttgtgtcc

SEQ ID NO: 5 - DNA, 20 bp, Artificial Sequence
  primer
aacccctccgctgtctctat

SEQ ID NO: 6 - DNA, 20 bp, Artificial Sequence
  primer
ctggaaatattggcgatggt

SEQ ID NO: 7 - DNA, 22 bp, Artificial Sequence
  primer
cgtgacaacctgtattcgttga

SEQ ID NO: 8 - DNA, 21 bp, Artificial Sequence
  primer
cccattgagtccatcgttagg

SEQ ID NO: 9 - DNA, 25 bp, Artificial Sequence
  primer
gcccagattatctatagaagcctta

SEQ ID NO: 10 - DNA, 20 bp, Artificial Sequence
  primer
aagcgacgaaaaggaaacaa

SEQ ID NO: 11 - DNA, 22 bp, Artificial Sequence
  primer
agaatacaacattccgcaccat

SEQ ID NO: 12 - DNA, 23 bp, Artificial Sequence
  primer
tctgtaaactgggaatcaagagg

SEQ ID NO: 13 - DNA, 22 bp, Artificial Sequence
  primer
acattctctgcagcgtatctca

SEQ ID NO: 14 - DNA, 22 bp, Artificial Sequence
  primer
tactttggcgggaattcttcta

SEQ ID NO: 15 - DNA, 22 bp, Artificial Sequence
  primer
aactaccagcaatggaccaact

SEQ ID NO: 16 - DNA, 25 bp, Artificial Sequence
  primer
gcagacactttttcttctgaaactc

SEQ ID NO: 17 - DNA, 22 bp, Artificial Sequence
  primer
tgctacttttgattggcatacg

SEQ ID NO: 18 - DNA, 22 bp, Artificial Sequence
  primer
tccattcaccgtacacttcaat